(19) United States
(12) Patent Application Publication
(10) Pub. No.: US 2019/0234601 A1
(43) Pub. Date: Aug. 1, 2019

(54) VEHICLE SIGNAL LIGHTING DEVICE

(71) Applicant: Richard Robert WESCOTT, Limestone, ME (US)

(72) Inventor: Richard Robert WESCOTT, Limestone, ME (US)

(21) Appl. No.: 16/256,104

(22) Filed: Jan. 24, 2019

Related U.S. Application Data
(60) Provisional application No. 62/709,676, filed on Jan. 26, 2018.

(51) Int. Cl. F21V 23/04; B60Q 1/44; B60Q 1/52; B60Q 1/54; F21S 43/14; F21S 43/30

(52) U.S. Cl. CPC F21V 23/0407; B60Q 1/44; F21S 43/30; B60Q 1/54; F21S 43/14; B60Q 1/52

(57) ABSTRACT

A signal lighting device may be provided. The signal lighting device may be used in conjunction with existing vehicle safety lighting features. The device may emit a high intensity flashing amber or yellow light to signal that a lead vehicle is either braking, slowing or stopping. The addition of the subject invention outlined within these documents is a natural and long overdue companion device-to a vehicles current brake and emergency lighting systems. The signal lighting device may utilize LEDs independently housed and controlled by a microcontroller. The device may be mounted, adhered of attached to a center of the vehicle location in the rear of the vehicle. The device may be designed for use on passenger cars, light trucks, motorcycles, RV's, OHRV's, trailers, campers, commercial vehicle and the like.

### PRIORITY CLAIM

This application claims priority to U.S. Provisional Patent Application No. 62/709,676, filed Jan. 26, 2018, the contents of which is hereby incorporated by reference in its entirety.

### TECHNICAL FIELD

The subject invention is a conspicuous inexpensive compact device, that when illuminated provides an effective companion device to a vehicles' traditional brake lights and emergency flasher systems. More specifically, the subject invention is an intentionally designed conspicuous illumination device that commands the attention of distracted vehicle operators following behind other vehicles.

### BACKGROUND

The forthcoming information relates to vehicle brake lights and rear of vehicle emergency flashers, which have used illumination of the color red for the past 100+ years, and very likely will for the next 100 years. A January 1918 Popular Mechanics magazine article explains how the first vehicle brake lights functioned. The article explains that a lever (switch) was fastened to the vehicle steering column. There were two diamond-shaped red lamps mounted on the rear of the vehicle. When the driver was preparing to stop the vehicle, they would lean forward and manually point the lever upward which would illuminate both lamps. The operator of the trailing vehicle was alerted that the lead vehicle was coming to a stop. Sometime later, the illumination of these two red brake lights would automatically occur when the driver of the vehicle depresses the brake pedal which activates the brake light switch, illuminating the brake lights.

History shows that it was not until 1986 when the Center High Mount Stop Lamp, or CHMSL, became mandatory for passenger car production. A study released in 1998 titled “NHTSA Technical Report Number DOT HS 808 696; the long-Term Effectiveness of Center High Mounted Stop Lamps in Passenger Cars and Light Trucks,” indicated that early studies of the CHMSL reduced rear-end collisions by about 50%. The report went on to say that once the novelty wore off as more vehicles came equipped with the CHMSL the crash avoidance benefit declined to 4.3%. Therefore, what is important to note is that the first significant update, since 1918, in a cost-effective way to assist in minimizing rear-end collisions was with vehicle safety lighting over 30 years ago. Still today, rear-end collisions remain as the leading cause of vehicle accidents causing property damage, personal and psychological injuries and in many instances, death. Statistically, one stands the highest risk of being in an accident during what has become the dangerous activity of braking, slowing or stopping the vehicle that they are operating.

The history of the brake light helps to understand the problem, and thus enables a direction to seek a solution. As discussed, studies have shown that the CHMSL was a very effective tool in decreasing the occurrences of rear-end collisions. Although, when the novelty wore off, so did the amount of accidents the CHMSL helped to prevent.

For over 100 years vehicle operators have been looking directly into red tail/brake lights and emergency flashers on the rear of vehicles. It is likely that this will continue well into the future as national and international guidelines mandate tail and brake lights to be red. Therefore, one cannot blame the innovations in brake lights that have been mandated to remain red. There has been some in the automotive industry that have suggested, specifically with modern day bright light emitting diodes, LEDs, that some vehicle operators have a hard time distinguishing when a vehicle in front of them is braking or simply turning on their tail lights. This is because the industry has no standard for brake light intensity, except to say that they should reach their maximum intensity at no more than 300 candelas. It therefore may be desired to eliminate this problem.

The illuminated brake light serves as a stimulus to perform an action, such as braking in semi-synchronicity with the lead vehicle. Looking at these same red brake lights for over 100 years has caused operator habituation. That is, we have a decreased sensitivity and responsiveness to the illuminated red brake lights because of the repeated and continuous exposure to the same stimulus. This de-sensitivity is evidenced in the history of the brake light. In the early 1980's rear-end collisions were at a record high as vehicle operators had been looking at the same red brake lights (stimulus) for nearly 60 years before the CHMSL was rolled out on new vehicle models. This innovation enjoyed success as an effective tool that helped to reduce rear-end collisions substantially. As also explained, this innovation also fell victim to habituation when vehicle operators became accustomed to the CHMSL which eventually led to a decrease in responsiveness over time. It became evident that when the CHMSL was first introduced it was conspicuous-that is, it was obvious to the eye and captured by the mind.

There is also a term known as retina fatigue. Studies have shown that when one has a long exposure to the color red, that retina fatigue can develop which decreases the susceptibility of sensory receptors. It is reported that such long-term exposure to the color red makes the red appear to turn gray. Although there were no studies found that directly linked red tail/brake lights to retina fatigue, there were also no studies found that examined any possible link between the two. This is simply another possible explanation for the high rates of rear-end collisions. An explanation that certainly has merit.

In a Jun. 8, 2015 report, the NHTSB estimated in the United States that there were 1.7 million reported rear-end collisions. That averages to be 3.2 rear-end collisions every minute of every day. This is nearly 30 years after the CHMSL made its debut in 1986 vehicle models. Similar reports from the surrounding years of the 2015 report have held that as many as 2.5 million reported and unreported rear-end collisions occur annually. This type of collision causes around 500,000 personal injuries and numerous deaths every year. It becomes evident that this problem needs new solutions and innovations in order to reduce the number of rear-end collisions. A Jun. 23, 2015 article found on ‘thenewswheel.com/the-history-of-brake-lights,’ reports that, although brake lights are a commonplace safety feature, it is still recognized as “much more important than any current safety technology.” Comprehensive research was discovered that was authored by the Chicago Tribune, while reporting on rear-end collisions which held that “the third-light mandate worked. As far back as 1995, an insurance institute study concluded that model year 1986 cars experienced 5 percent fewer rear-end collisions from 1986 through 1991 than would have been expected without the high-mounted lamp.” The article quotes Jennifer Stockburger, Director of Operations for ‘Consumer Reports’ Auto Test Center as stating, “Anything that makes you more visible is an improvement.” Higher visibility is the purpose and spirit of the subject invention.

The history of the vehicle brake light has indicated a call to arms for inventors and innovators to find remedies to the frequency of rear-end collisions. However, before one can find a solution to a problem they first need to understand the problem. This means that the ‘human factor’ must accompany the background, as the human factor plays the largest role in rear-end collisions. As an example, the neurophysiology of reactive time, according the stimulus-response model, human beings have an approximate reaction time of one-half of a second to events happening around them. This is the time that is required for the brains hard-wired laws of association to assemble various sensations in a coherent perception, and thus to inform the conscious mind-the frontal cortex -that a perceived event requires some analytical reflection and/or some decision-making process on our part. If a conditional reflex suffices to respond to an event, then the one-half of a second reaction time applies. If, however, one's response to an event requires some deeper analysis and judgment, our reaction time can be extended beyond a second or more. When operating a vehicle, one will require a combination of both types of responses; that is, conditional reflexes and analytical judgment.

A human's inherent delayed reaction time of nearly one-half of a second is seldom problematic or potentially dangerous when humans are performing low-speed, low risk activities. However, when we begin to operate at higher speeds that carry higher levels of risk, potential dangers increase and are magnified by delayed reactions. This is especially true when operating a vehicle, as evidenced by the 1.7 million reported rear-end collisions. As a neurological rule of thumb, it is fair to say that the faster the pace of human activity, the less response time a person has to react to the events or to avoid potential dangers.

As an example, two vehicles are travelling in the same lane of traffic in the same direction at 60 miles per hour, approximately 6 vehicle lengths apart; an estimated 85 feet. These two vehicles are traveling at 88 feet per second and, should the operator of the lead vehicle apply the vehicle brakes aggressively, the distance between the two vehicles will close rapidly. By the time the operator of the second vehicle has psychologically processed the event and is alert and attentive to the lead vehicle braking, they have travelled somewhere in the area of 44 feet, at 88 feet per second, and will safely synchronize their braking with the lead vehicle in order to avoid a collision. However, if the operator of the second vehicle is distracted for even one half of a second by a phone call, text message, disruptive passenger, daydreaming, or the local scenery, their reaction time significantly decreases, thus significantly increasing the risk of a rear-end collision. Taking this scenario one step further is to have multiple vehicles commuting in the same lane of traffic at approximately 85 feet apart from one another at 60 miles per hour. If any of the lead vehicles in this scenario has to perform an emergency stop and one of the operators of the trailing vehicles is distracted, they will not brake in time to avoid a collision. Further, the remaining trailing vehicles have not been provided ample warning of the situation making a multi-vehicle pile-up imminent.

Our attentiveness stems from our physical and mental health and well-being, and all too often sleep deprivation and personal thoughts will cause us to become inattentive to our environment. As a curative to delayed reaction time due to distraction or inattentiveness, conspicuity devices should continue to be introduced into the technical field of automotive lighting in order to improve the reaction time to reduce the incidence of rear-end collisions.

Humans are creatures of habit. When it comes to operating a vehicle, some operators have good instinctual habits while others simply don't. The braking reflex is often a conditioned response when a lead vehicles brake lights are illuminated. As explained above, habituation can and likely will occur as the illumination of red brake lights is an event witnessed countless times and many vehicle operators have been de-sensitized to. This is then exacerbated by a vehicle operator being tired, distracted or impaired. Neurophysiology however, also offers a clue on how to combat this problem and to command the attention of tired, distracted and impaired vehicle operators following other vehicles, as will be revealed below.

Most experienced vehicle operators are pre-conditioned to accept a more cautioning frame of mind when they observe an amber or yellow flashing light. For example, braking when they see a yellow traffic light, or when they observe amber or yellow flashing lights on construction signs, tow trucks, snowplows, wide load convoys and many other vehicles and incidence where cautionary lighting is used as a visual warning device.

We also know that a brief burst of light will command a person's attention by visual reflex. Take for example a flash of lightning a long distance away. If this sudden flash occurs within our peripheral vision, our attention is immediately drawn to the exact area where the flash occurred. The same effect can be seen when fireworks explode in the sky within our peripheral field of vision, or the flash of a camera from across a stadium. The visual system in humans is a centrally weighted area of high resolution and extreme sensitivity to movement and atypical received intensity. Any variation of these two parameters are given alternate priority. By understanding this, an improvement in the initiation of braking to the subsequent response of the drivers behind the braking vehicle can be produced by intensity notification. With this in mind, research was begun to determine if a device could be developed that would 1) emit high intensity flashes of light, 2) be amber or yellow in color, and 3) not fall victim to habituation shortly after its development and rollout to the public.

As explained, the optical recognition system in humans is centrally weighted not only in visual clarity as to motion and intensity but also consciousness. The area outside of this centrally weighted section is commonly known as one's peripheral field of vision, estimated to be approximately 180 degrees in diameter, or half of a circle. Only when some optically observable event of significance occurs will this intrude first in consciousness, then into direct attention with optical scrutiny. The scenario can be drastically improved by calling direct attention by an enhanced lighting system that will stimulate sufficient intensity into the peripheral field of vision and thus direct consciousness toward priorities among competing interest. Vast improvements in overall safety among complex systems is achieved when the subject invention is activated and commands one's attention back to a vehicles traditional brake lights.

In conclusion, there may be a need for an independent companion illumination device for the traditional brake lights and emergency flashers. The above text explains a generalized history and problems with traditional brake lights, as evidenced by the annual 1.7 million reported rear-end collisions. A solution to this problem may fulfill a long-felt yet unsolved need, where others have failed to develop an inexpensive protection, security and vehicle safety solution.

### SUMMARY

According to an exemplary embodiment, a signal lighting device may be provided. The signal lighting device may have a housing installed on the rear of a vehicle, which may house at least one light source. The light source may be yellow or amber. Furthermore, a printed circuit board may be provided, which supports a microcontroller connected to the at least one light source, at least one power supply, and a vehicle's brake or flasher wiring. The microcontroller may have code stored thereon for controlling the flashing of the at least one light source when the microcontroller receives input that a vehicle brake light or emergency flasher has been activated.

According to yet another exemplary embodiment, a method for attracting a following-driver's attention may be provided. The method may include providing a signal lighting device installed on the rear of a vehicle. Next, the user of brake lights or emergency flashers of the vehicle may be detected. Lastly, the signal lighting device may be activated to flash.

### BRIEF DESCRIPTION OF DRAWINGS

Advantages of embodiments of the present invention will be apparent from the following detailed description of the exemplary embodiments. The following detailed description should be considered in conjunction with the accompanying figures in which:

FIG. 1A shows an exemplary embodiment of a vehicle signal lighting device;

FIG. 1B shows an exemplary embodiment of a vehicle signal lighting device;

FIG. 2 shows an electrical schematic of an exemplary embodiment of a vehicle signal lighting device;

FIG. 3 shows an electrical schematic of an exemplary embodiment of a vehicle signal lighting device;

FIG. 4A shows an exemplary embodiment of a vehicle signal lighting device;

FIG. 4B shows an exemplary embodiment of a vehicle signal lighting device;

FIG. 5A shows an exemplary embodiment of a vehicle signal lighting device;

FIG. 5B shows an exemplary embodiment of a vehicle signal lighting device;

FIG. 5C shows an exemplary embodiment of a vehicle signal lighting device;

FIG. 6A shows an exemplary light projection pattern for an exemplary vehicle signal lighting device;

FIG. 6B shows an exemplary embodiment of a vehicle signal lighting device;

FIG. 7A shows an exemplary embodiment of a vehicle signal lighting device;

FIG. 7B shows an exemplary embodiment of a vehicle signal lighting device;

FIG. 7C shows an exemplary embodiment of a vehicle signal lighting device;

FIG. 7D shows an exemplary embodiment of a vehicle signal lighting device;

FIG. 8A shows an exemplary embodiment of a vehicle signal lighting device;

FIG. 8B shows an exemplary embodiment of a vehicle signal lighting device; and

FIG. 8C shows an exemplary embodiment of a vehicle signal lighting device.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequences of actions described herein can be performed by specific circuits (e.g. application specific integrated circuits (ASICs)) and/or by program instructions executed by at least one processor. Additionally, the sequence of actions described herein can be embodied entirely within any form of computer-readable storage medium such that execution of the sequence of actions enables the at least one processor to perform the functionality described herein. Furthermore, the sequence of actions described herein can be embodied in a combination of hardware and software. Thus, the various aspects of the present invention may be embodied in a number of different forms, all of which have been contemplated to be within the scope of the claimed subject matter. In addition, for each of the embodiments described herein, the corresponding form of any such embodiment may be described herein as, for example, “a computer configured to” perform the described action.

A companion lighting device to a vehicle's traditional brake lights may be provided. The companion lighting device may be designed to be used on passenger cars, motorcycles, trucks, ATV's, OHRV's, trailers, campers, snowmobiles and the likes thereof. The companion lighting device may enhance the braking signal of lead vehicles in order to draw the attention of operators of trailing vehicles of the lead vehicle operator's intent to slow or stop. This may be accomplished by providing several short bursts of high intensity amber or yellow flashing light for only or near a second. This 1) draws the attention to the braking, slowing or stopping vehicle 2) without a habit causing long exposure to the enhanced notification systems features and functions.

An added feature may allow for the device to activate in synchronicity with the vehicles' emergency flashers. This may allow for approaching vehicles to be alerted to a vehicles' emergency flashers by not only having existing red flashing lights, but also by providing amber or yellow bursts of flashing light in conjunction with the red flashing lights. The companion lighting device may further bring an enhanced notification to the illumination of a vehicles traditional red brake lights which have been utilized by the vehicle industry for more than 100 years, and may provide the additional emergency flasher feature.

Now referring to the Figures generally, a conspicuous signal lighting device 10 may be provided. Lighting device 10 may not be a traditional brake light. Instead, the signal lighting device 10 may be complementary to traditional brake lights and in some embodiments may be an amber or yellow high intensity illumination device. Signal lighting device 10 may be designed to enhance the effectiveness of a vehicle's traditional brake lights. The conspicuous signal lighting device may, when activated, illuminate as a high intensity amber or yellow flashing light, which may penetrate the peripheral field of vision of a driver. This may be particularly effective in drawing attention of distracted, tired or substance influenced driver and commands their attention to the braking vehicle. In an exemplary embodiment, the flashing may occur for approximately one second. This brief flashing of light may prevent further habituation of traditional brake lights and draw a vehicle operator's attention toward a lead vehicle and/or its traditional brake lights.

For the reasons outlined above and the practically unrestrained restriction, an amber or yellow flashing of light may be utilized in a signal lighting device for capturing the attention of the driver of a following vehicle. It may further be noted that research from several reviewed studies, including that of the National Highway Traffic Safety Administration, have indicated “amber rear signals rather than red ones are up to 28% less likely” to be involved in rear-end collisions. Although this particular report concerns the use of amber turn signals over the use of red ones, the same statistics should hold true to an amber signal lighting device used in a complementary manner to red brake lights.

According to some exemplary embodiments, signal lighting device 10 may have a beam pattern of approximately 10 degrees, which may be targeted to the attention of trailing vehicles. A desired beam pattern width may be accomplished using deflectors, partitions, or setting the illuminating element, such as an LED, to a certain depth within a housing. In an exemplary embodiment, a housing may be cylindrical, and the depth of the light may optionally be adjustable. A variety of types of lights may be used, such as incandescent as would be understood by a person having ordinary skill in the art; however, an exemplary embodiment may utilize LED lights, which may have increased durability, faster illumination, and increased service life.

According to an exemplary embodiment, a signal lighting device may utilize an optimal flash ratio. Research has shown that flashes of light per second and motion picture frames per second both may be similar to distinguish a person's optimal visual perception. For example, once a light begins to flash over 25 flashes per second or frames from a motion picture start to exceed 25 frames per second, either a constant light or fluid motion is perceived, respectively. Anything produced at 30 flashes or frames per second may not be distinguishable by the human eye or mind. When flashes are decreased, a person may perceive a flicker. Taking these findings, one may create a real-life example. For instance, two vehicles are travelling in the same direction at 60 miles per hour at a distance of approximately 85 feet apart, or just one second away from one another as they are moving at 88 feet per second. It may therefore be concluded that a flashing rate of one flash per second would not provide sufficient notification to a trailing vehicle that the lead vehicle is performing an emergency stop, where, as discussed above, a human's reaction time is approximately one-half of one second. Therefore, an exemplary embodiment of a signal lighting device may provide three high intensity amber or yellow light bursts in that half second, or a total of six flashes per second.

It may also be important to prevent a signal lighting device from falling victim to habituation. When a person is walking, riding or operating a vehicle, that they will see tow trucks, construction equipment, ambulances, fire equipment and police vehicles riding around and parked without their emergency lights being activated, and without these lights being activated we seldom give much attention to the vehicle. However, once we see the emergency warning lights activated, it may draw our immediate attention to whatever is going on. Its human nature. A person sees the flashing lights and immediately becomes curious because our brains are hardwired to understand that flashing lights mean activity, and people want to know what the activity is. When a signal lighting device is activated, people may see the brief flashing of light and immediately notice that the vehicle in front of them has applied the vehicle brakes.

Traditional brake lights may be illuminated whenever a vehicle brake pedal is depressed. This may be true even when someone is “riding the brakes” for miles with no immediate intention of slowing or stopping. Basically, the same red brake lights have been in existence for over 100 years, and when things get old, they tend to get stale, and in this case fall victim to habituation. It is said that the red brake lights remain the most effective safety warning device on vehicles, yet these red brake lights are getting slammed into a reported 1.7 million times a year in the United States alone. It may not be desirable to replace the traditional brake light, but instead, it may be desired to bring attention back to the traditional brake lights immediately upon their illumination. In order to do so, a prolonged flashing light, including one of amber or yellow color, may be counter-productive as it too would likely fall victim to habituation, and also be very annoying to vehicle operators. Therefore, in order to provide trailing vehicle operators ample warning of a lead vehicle's braking, slowing or intention to stop, and to avoid redundant, superfluous, habituating and prolonged exposure to the amber or yellow flashing lights, one second may be a sufficient amount of time to provide 6 warning flashes.

Further, an exemplary embodiment of a signal lighting device may be designed in a way to avoid repetitive flashes in a vehicle drive thru, stop-and-go traffic, parking lots or anywhere the vehicle brake pedal is being frequently depressed. Therefore, a signal lighting device may contain a feature where the device may not activate the flashing of the amber or yellow lights for a pre-determined period after the last time the brake pedal was depressed. This may help to prevent habituation and any unnecessary warning signal when a vehicle operator is already keenly aware of the traffic situation that they are in. The activation limiting feature may be implemented through code stored on at least one microcontroller or microprocessor, which may control the operation of the illumination elements. The activation limitation may, for example, prevent the illumination of the signal lighting device for approximately 30-45 seconds after each instance of operation. In other embodiments, the signal lighting device may limit operation if it has been triggered more than a pre-determined threshold over a certain time or distance of travel.

In addition to the added safety advantages of the signal lighting device when used in conjunction with brake lights, there may also be an added safety feature when a signal lighting device receives a signal or current from the vehicles existing emergency flashers, which may be received through a second input element.

The signal lighting device is not a brake light, but rather is a companion device to a vehicles existing brake lights and emergency flashers. Contrary to traditional brake lights, the signal lighting device may not be illuminated the entire period when a brake pedal is depressed. The signal lighting device may also not utilize any red lights, red filters, or red lenses as do traditional brake lights. Signal lighting device 10 may utilize amber or yellow colored lights, and these colors may be used interchangeably. While an exemplary embodiment described herein may use amber or yellow LEDs, this does not preclude the use of clear or colorless LEDs with an amber or yellow lens or filter. The term amber or yellow LEDs may be used for simplicity purposes and is not limiting to how the amber or yellow color is projected outside of the physical structure of an exemplary embodiment.

An additional benefit to the signal lighting device may be a secondary input to a microcontroller that may allow the signal lighting device to be activated in synchronicity with the existing emergency flashers on vehicles.

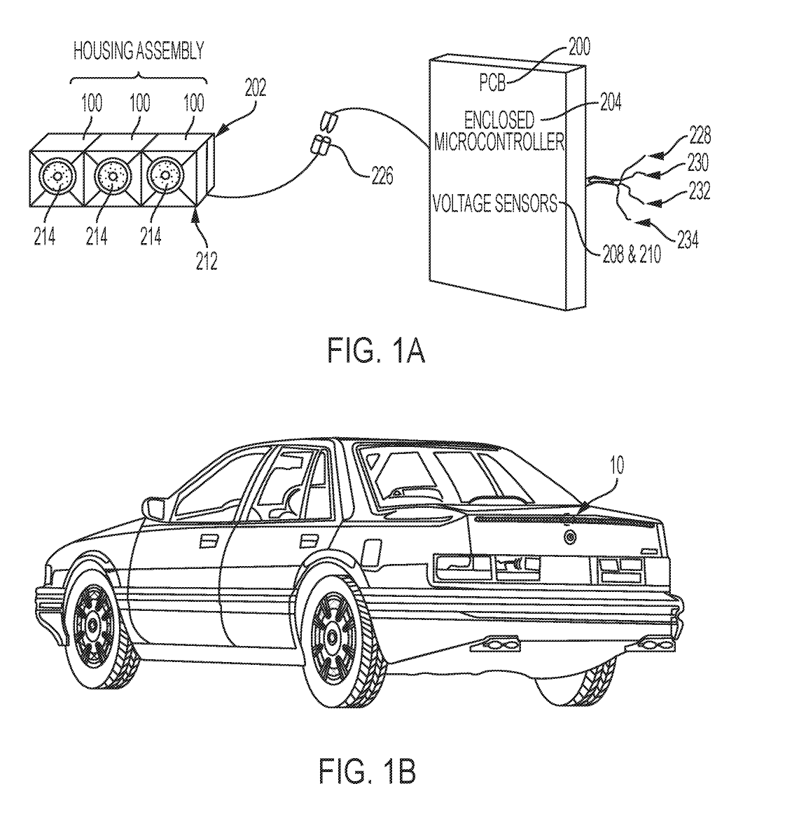

Now referring to exemplary FIG. 1A, a signal lighting device 10 may be provided. Signal lighting device 10 may include a housing assembly 100, which may contain at least one LED 214. Housing assembly 100 may optionally be a single unit comprising multiple LEDs 214 or may be multiple unites housing one or more LEDS 214. Housing assembly 100 may also contain a Printed Circuit Board (“PCB”) 202, on which LEDs 214 may be implemented. PCB 202 may be communicably connected to components on a PCB 200, which may include a microcontroller 204 and voltage sensors 208, 210. The connection may optionally be a wired connection by way of connectors 226, which may be double male/female connectors. PCB 200 may have further connections 228, 230, 232, and 234, which may be described in further detail below.

Now referring to exemplary FIG. 1B, a signal lighting device 10 may be shown installed on a vehicle. A vehicle may have a strip LED brake light on a trunk lid, wherein the strip LED is red. The device 10 of FIG. 1A, which may have 3 yellow LEDs, is incorporated into the center of the red LED strip, as shown in FIG. 1B.

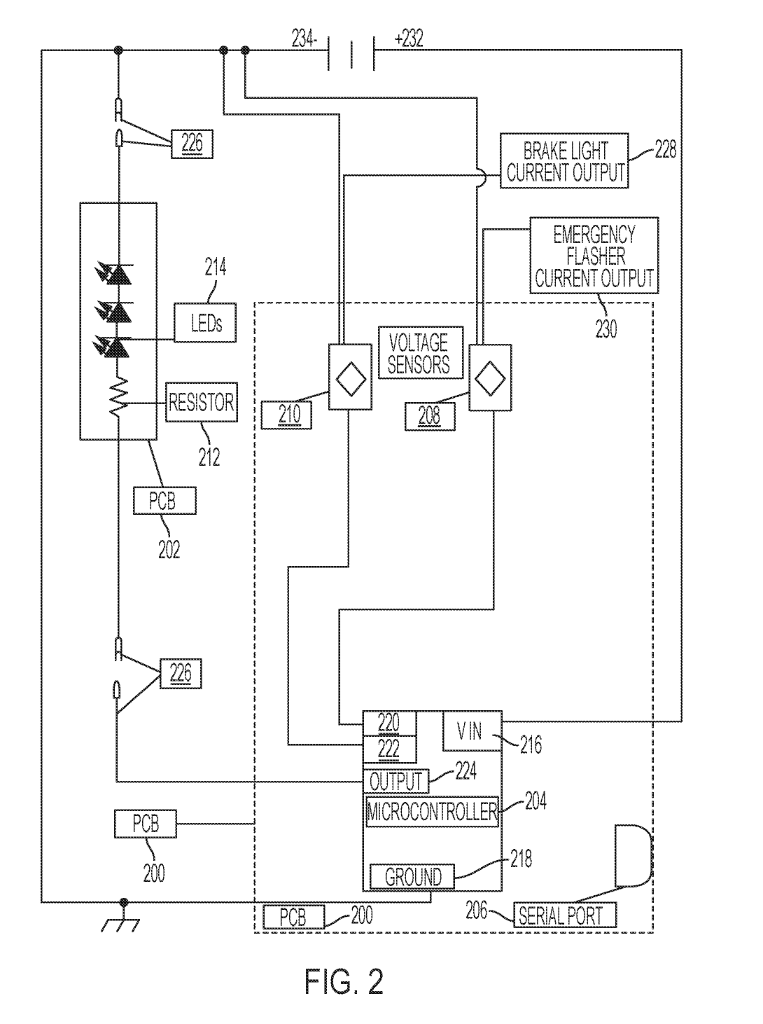

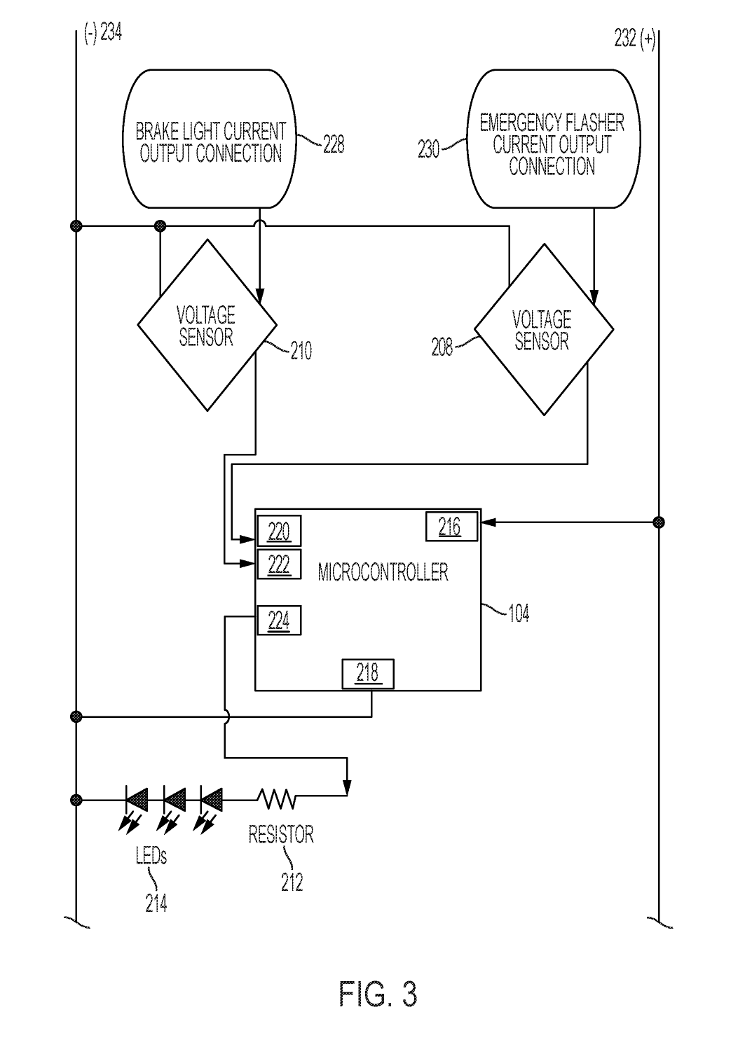

Now referring to exemplary FIGS. 2 and 3, an electrical diagram and flow chart of the components of signal lighting device 10 may be provided. As referenced above, signal lighting device 10 may have a PCB 202, which may support a resister 212 and one or more LED 214. These components may be communicatively coupled by way of connectors 226 to components of PCB 200. Components of PCB 200 may include one or more voltage sensors 208, 210, inputs 220, 222, voltage input 216, one or more output 224, one or more microcontroller 204, a ground 218, and one or more serial port 206. The electrical schematic of FIG. 2 may further show power source 232, 234, brake light current output 228 and emergency flasher current output 230.

According to some exemplary embodiments, a signal lighting device may include a microcontroller or in some alternative embodiments a microprocessor. In some further embodiments, multiple microcontrollers or microprocessors may be utilized, as well as additional components, such as timers, resistors, voltage regulators, shunts, capacitors, voltage sensors, emitters, diodes, controllers, switches, Zener diodes and the like, which may optionally all be installed on at least one printed circuit board, PCB. In some embodiments, LEDs may be provided in series; however, in other embodiments, a microcontroller or microprocessor may be capable of providing sufficient inputs and outputs to run LEDs in parallel or to enable them to operate independent of one another. The signal lighting device may receive power from a vehicle. The signal lighting device may be tapped or spliced into the vehicle's existing wiring system or in some embodiments a separate wiring harness may be provided. The microcontroller and amber or yellow LEDs may receive a constant power supply from vehicle in order to perform specific timed functions, as described herein. LEDs may not be illuminated until the circuit is closed by the microcontroller. The circuit may include a connection between vehicle and a ground or the chassis. The microcontroller may be grounded through the vehicle chassis ground, as may be the LEDs when the circuit is closed.

The microcontroller, according to at least one embodiment, may receive a signal or current from the vehicle's existing brake wiring, optionally by way of a wiring harness connection, when a brake pedal is depressed, and the vehicle brake lights are illuminated. This incoming signal or current may activate an integrated switch within the microcontroller which may close the circuit between the constant power supply from vehicle, the LEDs/resistor and the chassis ground. Once the microcontroller closes this circuit, allowing current to flow, the microcontroller may perform preprogrammed functions. One function of the microcontroller may be to flash the amber or yellow LEDs with an integrated flash timer, for exemplary purposes only, 6 times in approximately 1 second in a 50% on and 50% off duty cycle. A second function of the microcontroller may concern a second intergraded timer which may open the circuit, stopping current from flowing between the vehicle power supply, the LEDs/resistor and the vehicle chassis ground which may prevent the LEDs from flashing after approximately 1 second has elapsed. Finally, a third function of the microcontroller may concern a third integrated countdown or lockout timer which may temporarily deactivate any command to the integrated flash rate timer, which may prevent LEDs from receiving a flash command and illuminating for a period of, but not exclusively limited to, approximately 30 to 45 seconds from the last time the vehicle brake lights were activated. This feature may prevent the amber or yellow LEDs from flashing in situations likely to cause annoyance or habituation, such as stop-and-go traffic, a vehicle drive-thru, parking lots and other locations where the brake pedal is frequently depressed. A continued unnecessary and redundant signal may be contrary to the purpose and spirit of the signal lighting device 10, that is, to ensure that the signal lighting device 10 will remain effective for its designed purposes and for it not to fall victim to habituation similar to traditional red brake lights. In some exemplary embodiments, once approximately 30 to 45 seconds has elapsed without the brake pedal being depressed and the brake lights being illuminated, will the microcontroller again allow for the preprogrammed approximate 1 second flashing command to the LEDs to occur. The temporary deactivation may be for any desired time as would be understood by a person having ordinary skill in the art. It should be noted that individual components replacing the microcontroller, or used in conjunction with the microcontroller, may be incorporated as a potential manufacturing process in the overall operation of the various exemplified embodiments.

Further, the microcontroller may receive a separate signal or current from the tap or splice of the existing wiring harness of the vehicle's emergency flashers. Once a signal or current is received from the emergency flashers, the microcontroller may close the circuit including the vehicle power supply through the LEDs/resistor to the chassis ground. The microcontroller may allow for the current to flow only when it receives a signal or current from the vehicle's emergency flasher wiring harness indicating that the vehicles rear red bulbs, LEDs, or clear bulbs or LEDs with red lenses or filters are illuminated. This signal may cease being sent to the microcontroller when the bulbs or LEDs to the vehicle's emergency flashers are not receiving current. The signal or current from the emergency flashers may run in a duty cycle, for exemplary purposes only, of 50% on and 50% off. In such an embodiment, the vehicle's emergency flashers may be illuminated half of the time and not illuminated half of the time. When the vehicle's emergency flasher bulbs or LEDs are illuminated the signal or current may be sent to the microcontroller to close the circuit, allowing current to flow as defined above. Unlike commands from the microcontroller when it receives a signal or current from the vehicle's brake wiring harness, the signal or current from an emergency flasher wiring harness may bypass the countdown or lockout timer and proceed directly to the integrated flash rate timer. This may command the amber or yellow LEDs to flash at a rate of approximately 6 flashes per second that may be energized simultaneously with the duty cycle of the existing emergency flashers. If the vehicle's existing emergency flasher lights operate at a duty cycle of 2 seconds on and 2 seconds off, the signal lighting device's amber or yellow LEDs may flash approximately 12 times in that 2 seconds. If on the other hand the duty cycle for flashing the emergency flasher bulbs or LEDs is a 50/50 duty cycle of one half second, the signal lighting device's amber or yellow LEDs may flash 3 times during the time the vehicle emergency flasher bulbs or LEDs flash once.

As explained, the operation of the signal lighting device may be dual purpose. That is, the signal lighting device 10 may be activated once the microcontroller receives a signal or current from the existing brake light wiring harness, allowing the signal lighting device 10 to perform as described above. It can also be activated when a separate input in the microcontroller receives a signal or current from the existing wiring harness to the vehicle's emergency flashers. In some embodiments, the signal lighting device 10 may optionally be limited to one application. For example, signal lighting device 10 may be limited for use in a braking function as detailed above and not the emergency flasher function, or vice versa. In such embodiments, signal lighting device 10 may not be tapped or spliced into emergency flasher wiring harness or brake wiring in order to avoid transmitting a signal or current to the microcontroller. This may in no way affect the operation of the remaining application or applications.

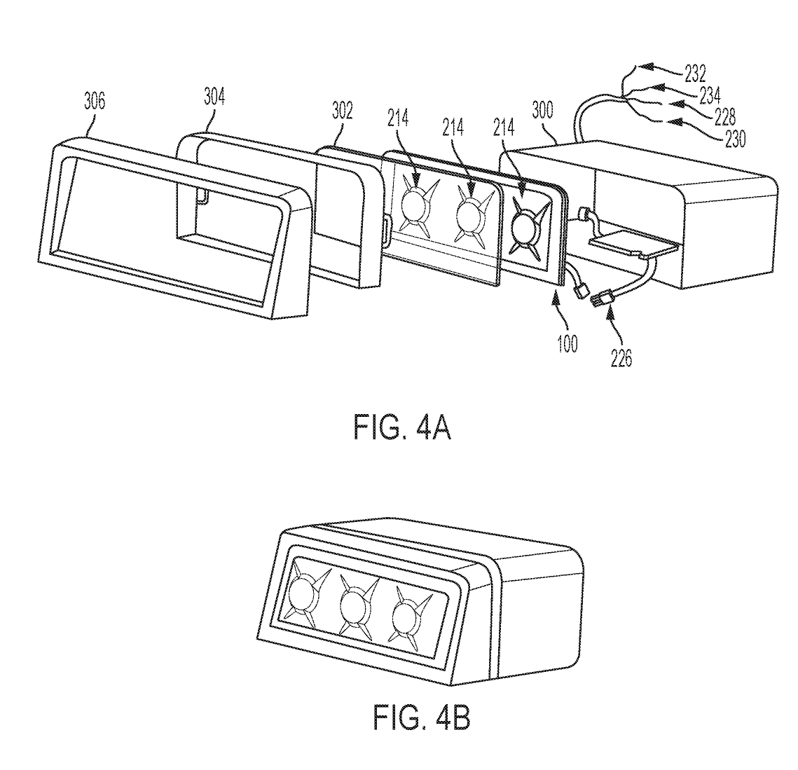

FIG. 4A-4B may show a signal lighting device. The components may be mounted into a housing structure or shell 300. In some embodiments, the components may be mounted using tape, double-sided tape, adhesive, screws or other fasteners as would be understood by a person having ordinary skill in the art. A wiring harness from the microcontroller containing lead wires for connections to components 232, 234, 228, 230 may be fed through a wall of shell 300 and may be connected to the signal or power source as defined above. In an exemplary embodiment, lead wires may be fed through a rubber grommet, which may optionally be air tight and/or water tight.

LEDs 214 may be mounted to an LED housing 100, which may be a reflective partition designed to reflect the light of the LEDs 214 outward through a clear lens 302. The clear lens 302 and the aforementioned LED partition 100 housing the LEDs 214 may be attached, optionally by snap fit, adhesive, or other fasteners, to the rear portion of the faceplate 214. A wiring harness from the LEDs may be connected to a microcontroller utilizing male/female connector 226. A faceplate 304 may be secured to the housing structure or shell 300. In some embodiments lens 302 may be implemented within faceplate 304. Faceplate 304 may be secured by a snap fit construction, adhesive, or other fasteners understood in the art. The components detailed above may be joined together as a single unit.

Finally, in order to meet the various angles of rear window applications, a curtain 306 may be provided. In some embodiments, curtain 306 may be soft rubber or a foam-like material. According to an exemplary embodiment, curtain 306 may have a variety of shapes or sizes to fit a desired vehicle, whereby curtain 306 may have a tapered angle matching the slope of a vehicle rear window. Foam curtain 306 may be an interchangeable piece. Signal lighting device 10 may be provided with multiple soft rubber-like or foam curtains 306 that can be selected to provide the best angle for the installation of the signal lighting device 10 onto a rear window or other vehicle location. The rubber-like or foam curtain 306 may have a double-sided tape or adhesive disposed on a front surface and/or rear surface. In an exemplary embodiment, one side may be adhered to the front of the faceplate 304 the other side may be adhered to the vehicles rear window. The soft rubber-like or foam curtain 306 may prevent light from LEDs 214 from bleeding through into the interior of the passenger compartment of a vehicle.

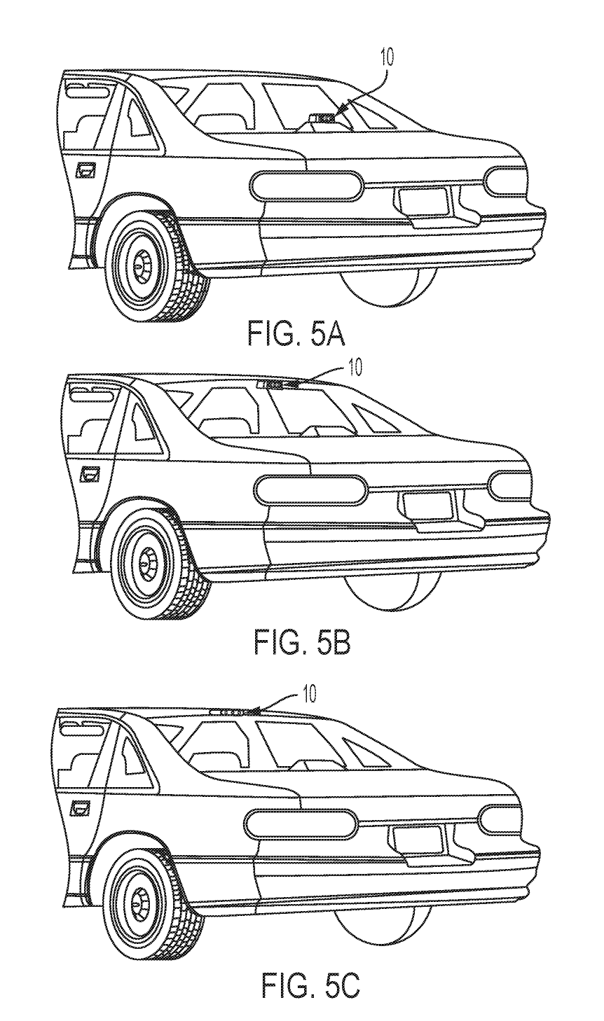

Now referring to exemplary FIG. 5A-5C, a signal lighting device 10 may be installed in a variety of locations on a vehicle. As shown in FIG. 5A, device 10 may be installed immediately above an existing CHMSL, hanging below an interior vehicle roof, as shown in FIG. 5B, or on an exterior vehicle roof as shown in FIG. 5C. As would be understood by a person having ordinary skill in the art, device 10 may be affixed in a desired location on a vehicle component or may be integrally installed in a vehicle, such as in a vehicle frame, trunk, a light fixture dedicated to the device or a combination light fixture, such as a CHMSL fixture.

According to at least one embodiment, signal lighting device 10 may be placed in the center portion of the vehicle to provide maximum effect. However, some alternative exemplary embodiments may utilize devices, optionally two identical devices, placed in the rear of the vehicle at an equal distance apart from the center of the vehicle. Providing the signal lighting device 10 in the center of the vehicle or having two synchronized, equally spaced devices 10 may avoid any confusion that the subject invention is an amber or yellow turn signal. Due to the overall light weight of an exemplary embodiment, the signal lighting device 10 may not require any additional support other than a high-quality double-sided tape, as applied to the faceplate 304 and curtain 306 as outlined above, for retrofit applications.

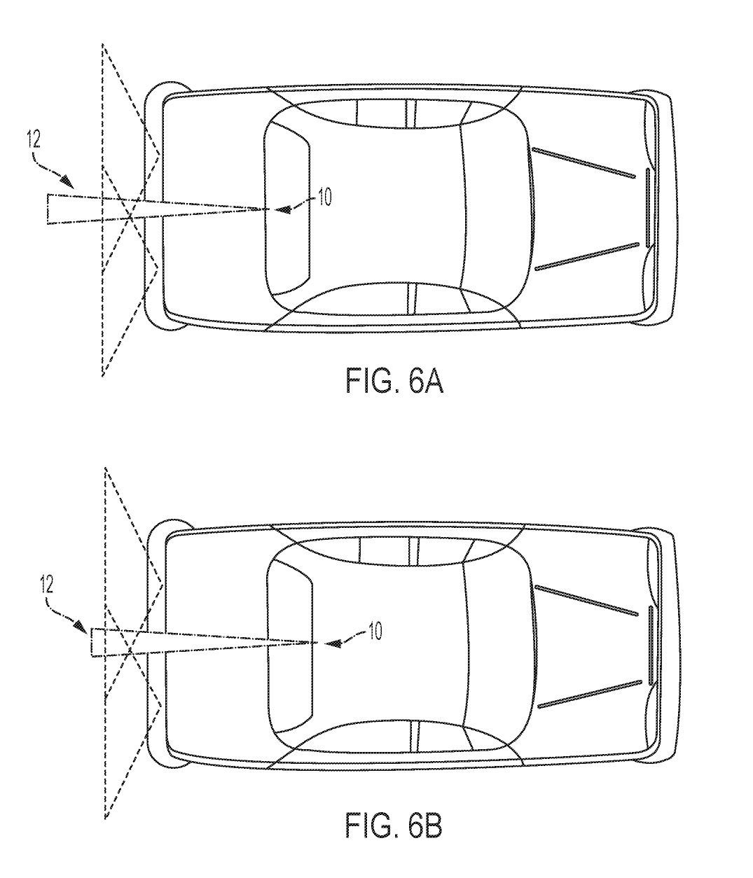

Now referring to exemplary FIGS. 6A and 6B, an exemplary projection pattern 12 of signal lighting device 10 may be shown. The projection angle may be shown as compared to the projection angle of the vehicle's existing brake lights. Furthermore, to intentionally and intrusively command the attention of a distracted driver following behind another vehicle, bringing the attention of distracted driver back to where it should be-directly in front of the path that their vehicle is travelling, a narrow beam width may be utilized. In an exemplary embodiment, the signal lighting device 10 may have a beam width of approximately 10 degrees. To accomplish a desired beam width, a light source of device 10 may be placed at an appropriate depth within a housing. In some alternative embodiments, curtains or sidewalls may extend from a device housing in order to guide the projection pattern 12. Furthermore, some embodiments may use light deflection devices, focusing elements, or filters, as would be understood by a person having ordinary skill in the art. These techniques and devices for creating a desired projection pattern may optionally be adjustable. Finally, an embodiment of the signal lighting device 10 may not utilize environmental light sensors and dimmers in order to ensure its objective of attracting attention is achieved. For example, someone may be travelling through a rain, snow or dust storm, or heavy fog conditions and the subject invention should not be dimmed in these types of conditions when the sensor believes it is night time.

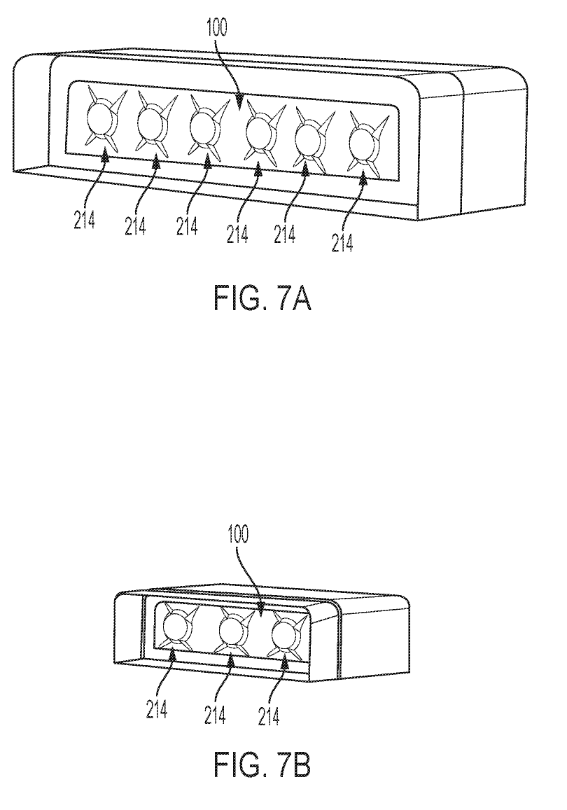

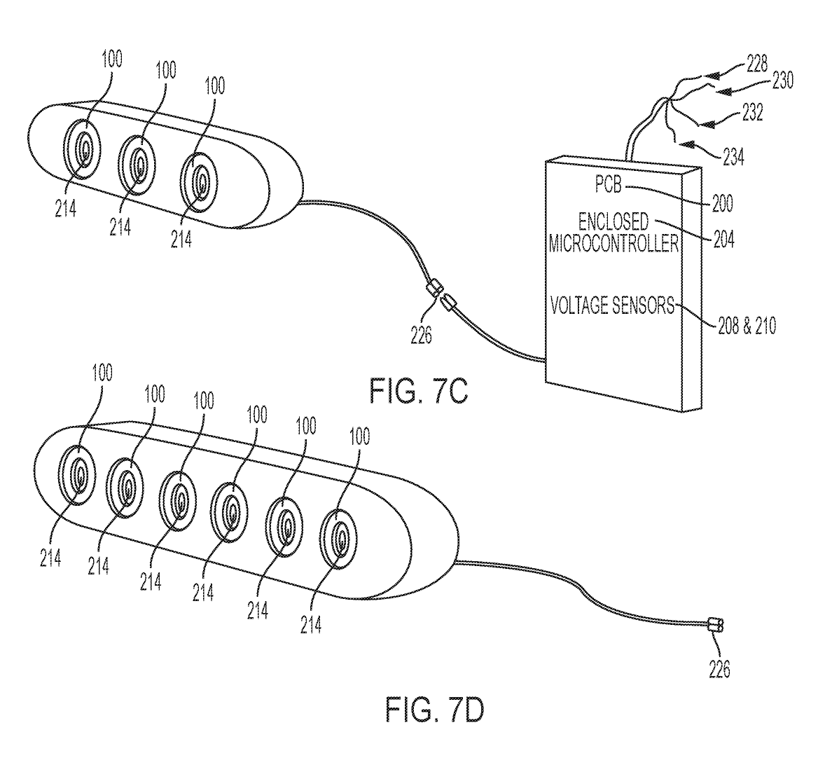

Now referring to FIGS. 7A, 7B, 7C, and 7D, exemplary embodiments may be provided. These embodiments may optionally be designed as external embodiments, which may be weatherproof and may include yellow or amber LEDs 214 installed within a housing 100 in order to achieve the functionality described herein. Exemplary embodiments may include LED strips containing any desired number of LEDs. LEDs 214 may optionally be set in individual housings 100 within a shell or may be arranged within a single integrated housing and shell. Still further, the depth of LEDs 214 within housing 100 or a shell may be adjusted to achieve a desired projection beam.

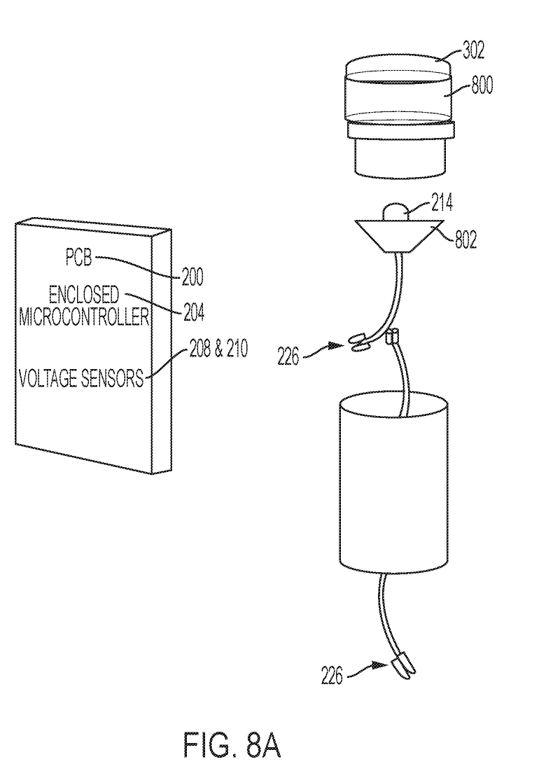

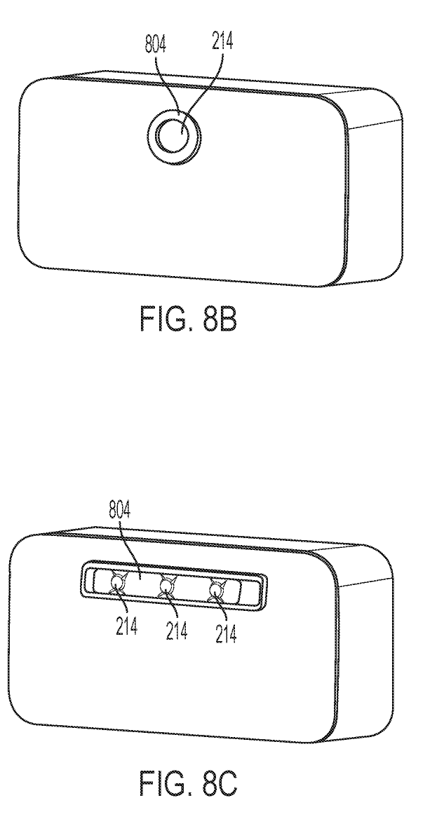

Now referring to exemplary FIGS. 8A-8B, embodiments using a single LED may be provided. As shown in FIG. 8A, a lens 302 may be provided on a housing 800, which may contain an LED 214 on a reflective LED mount 802. LED 214 may be connected to components, as described on PCB 200 above, via connectors 226. Single LED embodiments may include similar components to those embodiments described above and as shown in FIG. 8A. FIG. 8B may show the installation of a single LED embodiment installed within an existing brake light housing. Exemplary FIG. 8C may show a multiple LED embodiment installed within an existing brake light housing.

According to some embodiments microcontroller and LED 214 may be housed in the overall same structural housing; however, they may be separated by a partition 804 that may have a reflective, chrome-like finish that faces outside of the housing structure lens 302 and faceplate 304. The partition 804 may serve as a mounting platform and reflective housing for the LEDs 214. In an exemplary embodiment, as shown in FIG. 4D, the LEDs 214 and microcontroller may be remote from one another and connected by a male/female connection 226 for the purpose of ease of manufacturing and installation. Microcontroller and LEDs 214 may be an undetermined distance apart from one another according to various embodiments. It may be highly anticipated that different manufacturers may customize a signal lighting device to custom fit specific vehicle models and ensure that the signal lighting device is aesthetically appealing to their particular product lines.

The components of signal lighting device 10 may be manufactured with an automotive grade plastic, fiberglass, carbon fiber, composite or metal material. For external applications, a material used may be paintable and weather resistant to match the vehicle paint scheme. Further, the housing structure for the microcontroller and LEDs 214 may be pre-existing in a vehicle into which the signal lighting device is being installed. For example, a motorcycle tail/brake light or CHMSL. Therefore, various housing structures may not take away from the purpose and spirit of the signal lighting device 10 if it is manufactured and installed as described herein. The Figures, generally, may provide for and outline the process and components that allow for the simultaneous flashing of high intensity amber or yellow LEDs 214 at a flashing rate of approximately 6 flashes per second. The development of this particular operation of the signal lighting device 10 was based on much research. Thus, concluding from the research that approximately 6 flashes per second with a duty cycle of 50% on time and 50% off time to be an optimal setting. In order to avoid redundant writing, the particulars of the time/flash ratio recommendation may be further detailed in the Background/Advantages section. This is a recommendation only and in no way precludes one from adjusting either the flashes per second or changing the 1 second flash interval. In fact, doing so does not change the overall purpose of, or the spirit of the signal lighting device. However, it may or may not change the effectiveness for better or for worse. In some embodiments, adjusting the frequency may be utilized to further avoid habituation. Furthermore, in some embodiments, the frequency or intensity may be adjusted in correlation to the speed at which a vehicle is decelerating, as would be understood by a person having ordinary skill in the art. Activation of lighting device 10 may optionally be limited by the microcontroller as a function of vehicle speed. In such embodiments, microcontroller may comprise independent speed calculating components, such as a GPS transceiver, or may be communicatively coupled with a vehicle speedometer or speed measuring components. This may, for example, be used to limit repetitive activation during stop and go traffic or other low speed situations. In some further embodiments, the GPS component may be utilized to trigger the signal lighting device when a vehicle is slowing, but a brake has not been applied or a brake light has not been activated. This may optionally be triggered by slowing at a predetermined threshold rate, for example. In other embodiments, the signal lighting device may require braking to be activated. In still further embodiments, the frequency or brightness of the signal lighting device may be a function of the pressure or force applied to a brake, as would be understood by a person having ordinary skill in the art.

Some exemplary embodiments of a signal lighting device 10 may utilize LEDs 214 due to increased reliability and vibration resistant properties, which may not be characteristic of incandescent bulbs. Furthermore, LEDs may become fully illuminated faster than incandescent bulbs by ⅔rds of a second and have an average 30,000 to 50,000 hour service lifespan. For LEDs 214 to perform at optimum effectiveness and range, a microcontroller may be more efficient than individual components, however, either may be utilized. Microcontroller may be coded by one skilled in the art, to fire a current that produces an on time of 1 millisecond and an off time of 100 milliseconds, a 1/100 duty cycle. This may not be visible to the human eye and may help keep the LEDs 214 cooler, last longer and to perform with optimal brightness.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A signal lighting device comprising:
a housing installed on a rear of a vehicle;
at least one light source disposed within the housing, wherein the light source is yellow or amber; and
a printed circuit board supporting a microcontroller connected to the at least one light source, at least one power supply, and a vehicle's brake or flasher wiring, wherein the microcontroller comprises code stored thereon for controlling flashing the at least one light source when the microcontroller receives input that a vehicle brake light or emergency flasher has been activated.

2. The signal lighting device of claim 1, wherein the housing further comprises a reflective partition on which the at least one light source is mounted.

3. The signal lighting device of claim 1, further comprising a curtain configured to adhesively connect between the housing and a vehicle window.

4. The signal lighting device of claim 1, wherein the microcontroller is programmed to cause the light source to flash at a rate of six flashes per second.

5. The signal lighting device of claim 4, wherein the microcontroller further comprises code for limiting activation of the at least one light source based on repetition time parameters.

6. The signal lighting device of claim 5, wherein the microcontroller further comprises code limiting activation of the at least one light source to one activation per 30 second period.

7. The signal lighting device of claim 4, wherein the microcontroller further comprises code limiting activation of the at least one light source as a function of vehicle speed.

8. The signal lighting device of claim 1, wherein the at least one light source is an LED.

9. The signal lighting device of claim 1, wherein the at least one light source has a projection pattern angle of 10 degrees.

10. The signal lighting device of claim 9, wherein the depth of the light source defines the projection pattern angle.

11. A method for attracting a following-driver's attention comprising:
providing a signal lighting device installed on a rear of a vehicle;
detecting the use of brake lights or emergency flashers of the vehicle;
activating the signal lighting device to flash;
stopping the flash of the signal lighting device; and
monitoring for subsequent use of brake lights or emergency flashers for subsequent activation of the signal lighting device.

12. The method of claim 11, wherein the signal lighting device comprises a housing installed on a rear of a vehicle; at least one light source disposed within the housing, wherein the light source is yellow or amber; and a printed circuit board supporting a microcontroller connected to the at least one light source, at least one power supply, and a vehicle's brake or flasher wiring, wherein the microcontroller comprises code stored thereon for flashing the at least one light source when the microcontroller receives input that a vehicle brake light or emergency flasher has been activated.

13. The method of claim 12, further comprising limiting the signal lighting device to flash for a period of one second at a rate of six flashes per second.

14. The method of claim 12, wherein the signal lighting device has a projection angle of 10 degrees.

15. The method of claim 12, further comprising limiting the activation of the signal lighting device based on a pre-determined time period from a previous activation.

16. The method of claim 12, further comprising limiting the activation of the signal lighting device as a function of vehicle speed.
